(19) United States
(12) Patent Application Publication
(10) Pub. No.: US 2007/0214964 A1
(43) Pub. Date: Sep. 20, 2007

(54) Method for removing bubbles from slurry and device therefor

(75) Inventors: Koichi Miyashita, Kasugai-city (JP); Yukihito Ichikawa, Nagoya-city (JP)

Correspondence Address: OLIFF & BERRIDGE, PLC, P.O. BOX 19928, ALEXANDRIA, VA, 22320, US

(73) Assignee: NGK INSULATORS, LTD., NAGOYA-CITY (JP)

(21) Appl. No.: 11/712,950

(22) Filed: Mar. 2, 2007

(30) Foreign Application Priority Data
Mar. 16, 2006 (JP) 2006-072361
Jan. 10, 2007 (JP) 2007-001910

(51) Int. Cl. B01D 19/00

(52) U.S. Cl. 96/193

(57) ABSTRACT

There is disclosed a method for removing bubbles from a slurry and a device therefor capable of efficiently optimizing the removal of bubbles from a slurry and the viscosity of the slurry as well as dramatically reducing the bubble removing time. The device for removing bubbles from a slurry comprises a hopper 1 for charging a predetermined amount of slurry 2 including liquid and a high concentration of solid material agitated and dispersed in the liquid with the slurry containing bubbles to be removed therein; a bubble removing unit 20 disposed downstream of the hopper 1 and having a bubble removing plate 10 disposed downstream of the hopper 1 for discharging the slurry 2 containing bubbles to be removed therein in the form of and noncontact filaments or noodles; a slurry tank 3 connected downstream of the bubble removing unit 20; a vacuum unit 30 for evacuating the slurry tank 3 when the bubble removing unit 20 is used; and an air introduction unit 40 for introducing air for pressure-delivering the slurry 6 which is contained in the slurry tank 3 from the bubble removing unit 20 with bubbles removed to the outside.

### BACKGROUND OF THE INVENTION

1. Field of the Invention

The present invention relates to a method for removing bubbles from a slurry and a device therefor.

2. Description of the Related Art

When a high concentration of solid material is agitated and dispersed in the liquid, a slurry can be obtained as a fluidized suspension. In particular, a slurry used for a ceramic product or a ceramic repairing material, such as a slurry cast material, a plugging material for a honeycomb structure filter or an outer peripheral coating material for a honeycomb structure, comprises a ceramic slurry which is manufactured from a ceramic powder (solid material) as a starting raw material. The ceramic powder is dispersed in a solvent to prepare a ceramic slurry. Air is included in the processes of mixing, agitation, kneading, dispersion and the like and air bubbles are dispersed and mixed into the slurry.

For example, in case the slurry prepared above is used for a ceramic product of which high concentration, uniformity and denseness are required, air bubbles in the slurry may act as an obstacle thereto, and accordingly, air bubbles in the slurry must be removed.

Thus, for example, there have been mainly used a method (1) for adding a defoaming agent to a slurry for removing bubbles; a method (2) for giving a slurry vibrations; and a method (3) for introducing a slurry into a decompressed container per batch, and after decompression and deaeration, taking the slurry out of the container.

However, the method (1) for adding a defoaming agent to a slurry for removing bubbles cannot remove air bubbles in the slurry although it is effective for removal of air bubbles on the surface. A product prepared using such a slurry causes inner air bubbles to appear in a finish-grinding and polishing processes thus resulting in surface defects.

The method (2) for giving a slurry vibrations can remove large air bubbles while it cannot remove extremely small air bubbles 3 mm or below in diameter.

The method (3) for introducing a slurry into a decompressed container per batch, and after decompression and deaeration, taking the slurry out of the container is extremely inefficient because deaeration takes place per batch and is thus not suited for mass-production. It is difficult for this method to fully remove air bubbles when the viscosity of the slurry is high. Moreover, the slurry is exposed to vacuum for a prolonged time, which may substantially change the water amount due to drying.

In addition, the viscosity of a slurry is raised and becomes hard to handle if air bubbles are completely removed. Thus, air bubbles having such a fine diameter that a problem does not occur when a product is finished are dispersed, ideally, but this goal is hard to attain with the methods (1) to (3).

### SUMMARY OF THE INVENTION

The present invention has been accomplished in view of the problems with the above prior art, and the aims of the present invention is to provide a method for removing bubbles from a slurry and a device therefor capable of efficiently optimizing the removal of bubbles from a slurry and the viscosity of a slurry as well as dramatically reducing the bubble removing time.

In order to attain the above-mentioned aims, the present invention provides the following method for removing bubbles from a slurry and the device therefor.

[1] A method for removing bubbles from a slurry comprising liquid and a high concentration of solid material agitated and dispersed in the liquid with the slurry containing bubbles to be removed therein, the method comprising the step of dropping the slurry into a slurry tank under vacuum, while discharging the slurry containing bubbles to be removed therein in the form of a number of and noncontact filaments or noodles, this step being performed at least once.

[2] The method for removing bubbles from a slurry according to [1], wherein the degree of vacuum in the slurry tank is 0.013 to 6.7 kPa.

[3] The method for removing bubbles from a slurry according to [1] or [2], wherein the viscosity of a slurry is 50 to 500 dPa's.

[4] A device for removing bubbles from a slurry, comprising a hopper for charging a predetermined amount of slurry comprising liquid and a high concentration of solid material agitated and dispersed in the liquid with the slurry containing bubbles to be removed therein; a bubble removing unit disposed downstream of the hopper and having a bubble removing plate disposed downstream of the hopper for discharging the slurry containing bubbles to be removed therein in the form of a number of and noncontact filaments or noodles; a slurry tank connected downstream of the bubbles removing unit; a vacuum unit for evacuating the slurry tank when the bubble removing unit is used; and an air introduction unit for introducing air for pressure-delivering the slurry with bubbles removed which is contained in the slurry tank from the bubble removing unit to the outside.

[5] The device for removing bubbles from a slurry according to [4], wherein the size of a discharge hole made in the removing bubbles plate is 0.5 to 20 mm in a conversion of diameter.

[6] The device for removing bubbles from a slurry according to [4] or [5], wherein a further bubble removing unit having an identical feature to the bubble removing unit is provided in the slurry tank.

[7] The device for removing bubbles from a slurry according to any one of [4] to [6], wherein the bubbles removing plate disposed in the bubble removing unit comprises a plurality of bubble removing plates disposed in a plurality of stages, the number of stages being 2 to 20.

The method for removing bubbles from a slurry and the device therefor according to the present invention can efficiently optimize the removal of bubbles from the slurry and the viscosity of the slurry as well as dramatically reducing the bubble removing time.

### BRIEF DESCRIPTION OF THE DRAWINGS

FIG. 1 is a schematic explanatory view of an example of a device for removing bubbles according to the invention;

FIG. 2 is a schematic explanatory view of another example of a device for removing bubbles according to the invention;

FIG. 3 is a view shown in the direction of arrow A- in FIG. 2;

FIG. 4(a) is a front view of an exemplary bubble removing plate used in the present invention;

FIG. 4(b) is a cross sectional view, taken along the line A-A of FIG. 4(a);

FIG. 5 is a front view of another exemplary bubble removing plate used in the present invention; and

FIG. 6 is a graph showing a bubble diameter distribution with respect to the amount of bubbles in the slurry in Example and Comparative Example.

### DESCRIPTION OF THE PREFERRED EMBODIMENT

The method for removing bubbles from a slurry and the device therefor according to the present invention will be described in detail based on specific embodiments, but the present invention should not be construed as limited to these embodiments and various changes, modifications or improvements can be made to it based on the knowledge of those skilled in the art without departing from the scope of the invention.

The principal feature of the present invention resides in that bubbles are removed from a slurry comprising liquid and a high concentration of solid material agitated and dispersed in the liquid with the slurry containing bubbles to be removed therein, by dropping the slurry into a slurry tank under vacuum, while discharging the slurry containing bubbles to be removed therein in the form of a number of and noncontact filaments or noodles, this step being performed at least once.

In the method for removing bubbles in accordance with the invention, the degree of vacuum in the slurry tank is preferably 0.013 to 6.7 kPa (0.1 to 50 Torr). This is because a general-purpose vacuum pump can be used in this range.

Furthermore, in the method for removing bubbles in accordance with the present invention, the viscosity of a slurry is preferably 50 to 500 dPa's and more preferably 100 to 300 dPa's. This is because it is easier to insert a slurry into cell passageways within this slurry viscosity range.

In this way, the method for removing bubbles in accordance with the present invention efficiently optimizes the removing bubbles of a slurry and the viscosity of a slurry as well as dramatically reducing the bubble removing time.

Next, a device for removing bubbles according to the present invention will be described based on drawings.

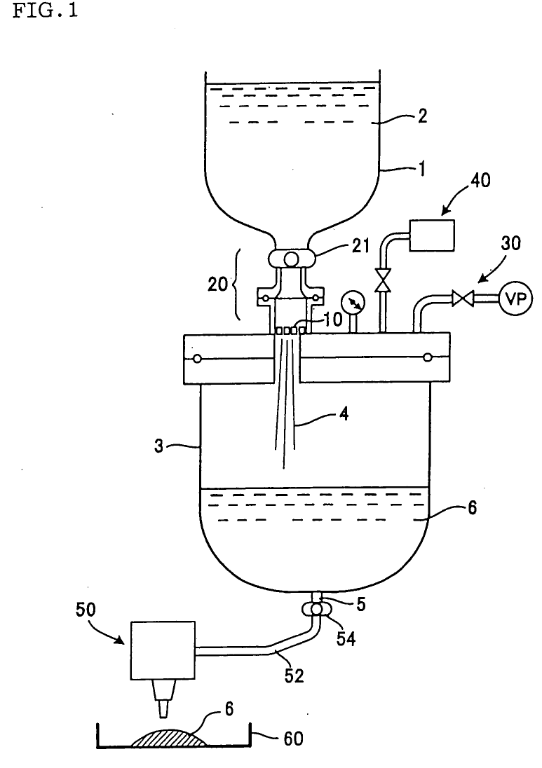

FIG. 1 is a schematic explanatory view of an example of a device for removing bubbles according to the present invention. FIG. 2 is a schematic explanatory view of another example of a device for removing bubbles according to the present invention.

For example, as shown in FIG. 1, the device for removing bubbles according to the present invention comprises a hopper 1 for charging a predetermined amount of a slurry 2 comprising liquid and a high concentration of solid material agitated and dispersed in the liquid with the slurry containing bubbles to be removed therein; a bubble removing unit 20 disposed downstream of the hopper 1 and having a bubble removing plate 10 disposed downstream of the hopper 1 for discharging the slurry 2 containing bubbles to be removed therein in the form of a number of and noncontact filaments or noodles; a slurry tank 3 connected downstream of the bubble removing unit 20; a vacuum unit 30 for evacuating the slurry tank 3 when the bubble removing unit 20 is used; and an air introduction unit 40 for introducing air for pressure-delivering the slurry 6 with bubbles removed which is contained in the slurry tank 3 from the bubble removing unit 20 to the outside.

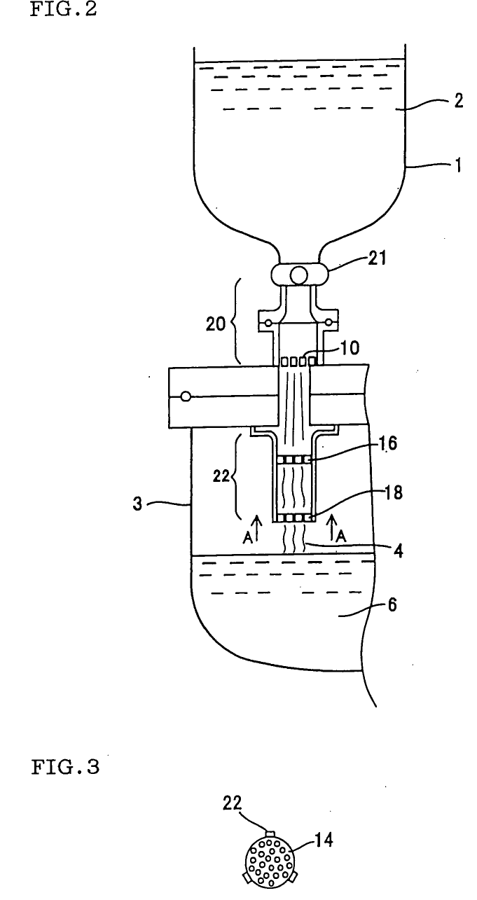

For example, as shown in FIGS. 2 and 3, the device for removing bubbles according to the present invention may further include a bubble removing unit 22 in the slurry tank 3 of the device shown in FIG. 1.

Furthermore, in the device for removing bubbles according to the present invention, but not limited to, for example, in the device shown in FIG. 1, the bubble removing unit 20 is turned on/off, by opening/closing a ball valve 21. In addition, in the lowermost part of the slurry tank 3 is disposed a ball valve 54 for opening/closing a pressure-delivering port 5 for the slurry 6 from which bubbles are removed. The slurry 6 is pressure-delivered to a slurry pressure-delivering pump (pump for viscous material) 50 via a pipe 52. The slurry pressure-delivering pump 50 quantatively pumps the slurry 6 from which bubbles are removed such as a plugging material onto a service dish (plate) 60. The slurry used in this method is prepared by a method using a normal (normal-pressure) vertical kneader.

Here, the bubble removing unit used in the present invention may include a single bubble removing plate disposed therein, but the bubble removing unit may preferably include bubble removing plates 16, 18 disposed in a plurality of stages in the bubble removing unit, as shown in FIG. 2, depending on the properties of a slurry containing bubbles therein such as the bubble diameter distribution and the viscosity, since it is possible to efficiently optimize the removal of bubbles of a slurry and the viscosity of a slurry as well as dramatically reducing the bubble removing time. The number of the stages of the bubble removing plates is preferably, but not limited to, 2 to 20.

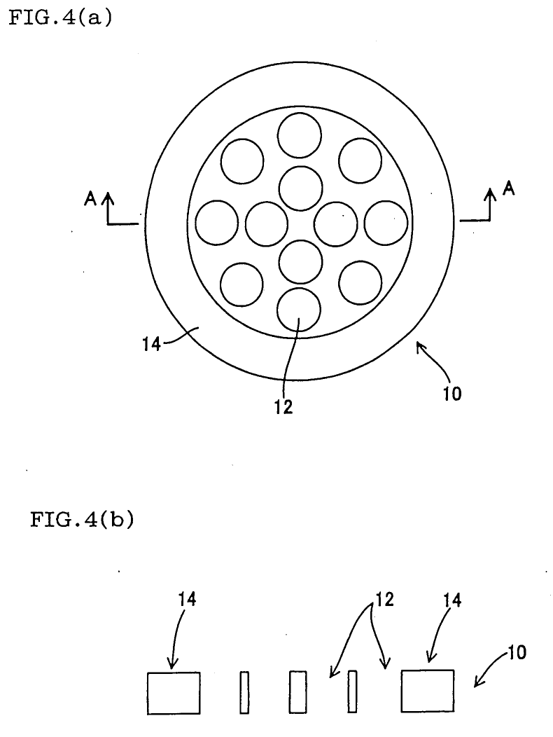

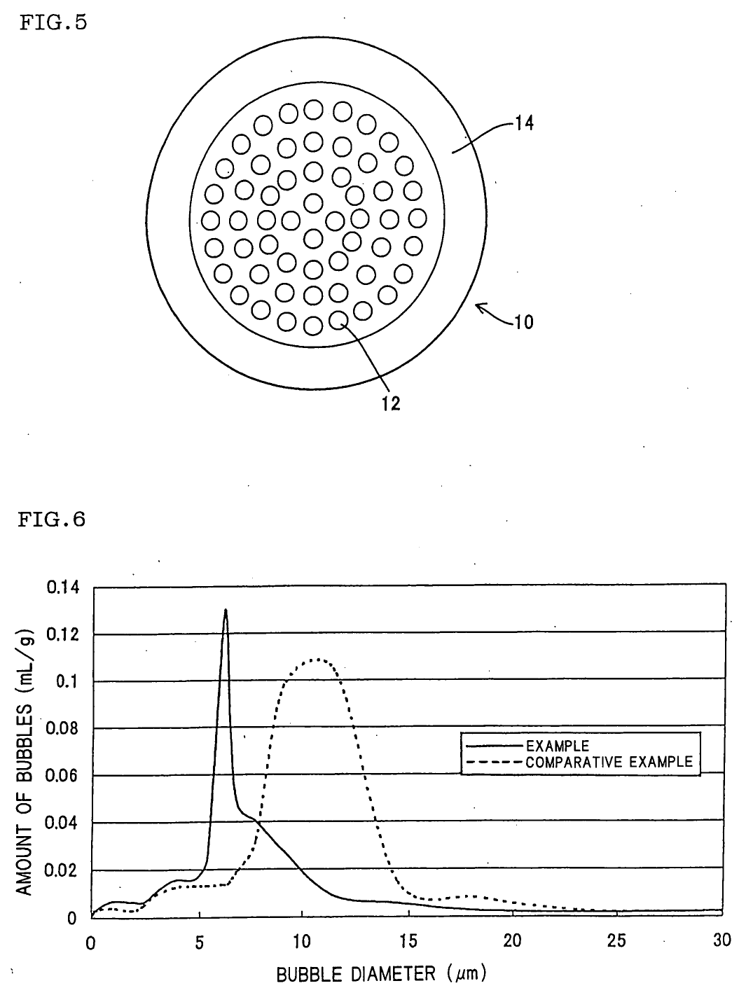

The bubble removing plate used in the present invention is not especially limited as far as a part in contact with the bubble removing unit is sealed and it is capable of discharging the slurry containing bubbles to be removed in the form of a number of and noncontact filaments or noodles. For example, the removing bubbles plate 10 shown in FIG. 4(a), 4(b) or 5 is preferred. The bubble removing plate 10 shown in FIG. 4(a), 4(b) or 5 comprises a plurality of discharge holes 12 pierced at intervals (pitches) to allow slurry with bubbles to be discharged in the form of a number of and noncontact filaments or noodles. On the outer peripheral portion of the bubble removing plate 10 is disposed a seal surface 14 that comes into contact with the bubble removing plate 10 when it is contained in the bubble removing unit.

The discharge holes 12 provided in the bubble removing plate used in the present invention is preferably 0.5 to 20 mm in a conversion of diameter.

In an exemplary procedure for operating the device for removing bubbles according to the present invention, as shown in FIG. 1, the slurry tank 3 is evacuated by the vacuum unit 30 (with the ball valves 21 and 54 closed) and then a slurry 2 containing bubbles to be removed is charged the hopper 1. After the slurry 2 containing bubbles to be removed is contained in the hopper 1, the ball valve 21 is opened up, and thus the slurry 2 containing bubbles is introduced into the bubble removing unit 20 so that the slurry 4 in the form of a number of and noncontact filaments or noodles is discharged into the slurry tank 3 (on that occasion, the state is that the slurry containing bubbles to be removed is withdrawn by vacuuming into the slurry tank 3 since the slurry tank 3 is maintained under vacuum). The discharged slurry 4 is contained in the slurry tank 3. When the bubble removing processing of the slurry is over, the slurry tank 3 is restored to normal pressure.

In addition to the slurry 6 from which bubbles are removed is pressure-delivered from the pressure-delivering port 5 of the slurry tank 3 to the slurry pressure-delivering pump 50 via the hose 52, by the air introduced into the slurry tank 3 by the air introduction unit 40. Furthermore, the slurry 6 from which bubbles are removed is pumped onto the service dish (plate) 60 from the slurry pressure-delivering pump 50 as required.

From the above, the bubble removing device according to the present invention can remove bubbles from the slurry with a simpler facility than with a conventional device and substantially suppresses mixing of air into the slurry after bubbles are removed.

### EXAMPLE

The present invention will be described by way of a specific example which does not limit the present invention.

(Method for Preparing a Slurry Containing Bubbles to be Removed)

Forty-five parts by mass of distilled water, a binder (methyl cellulose) and 10 parts by mass of a dispersant or the like were added to 100 parts by mass of a cordierite-forming material powder, and the material was mixed and kneaded with a mixer for one hour under normal pressure to obtain a slurry containing bubbles to be removed. The viscosity of the slurry containing bubbles to be removed was 200 dPa's.

### EXAMPLE

The slurry from which bubbles were removed was obtained from the above-mentioned slurry containing bubbles to be removed, by using the bubbles removing device shown in FIG. 1. The bubble removing time was 50 L/5 minutes and the then degree of vacuum of the slurry tank 3 was 6.7 kPa (50 Torr). The bubble diameter distribution with respect to the amount of bubbles in the slurry containing bubbles was measured using a mercury porosimeter. The result is shown in FIG. 6.

### COMPARATIVE EXAMPLE

The bubble diameter distribution with respect to the amount of bubbles in the slurry containing bubbles to be removed was measured using a mercury porosimeter. The result is shown in FIG. 6.

### STUDY: EXAMPLE, COMPARATIVE EXAMPLE

From the result shown in FIG. 6, Comparative Example showed a broad peak around a bubble diameter of 10 to 12 μm while Example showed a sharp peak around a bubble diameter of 6 μm. That is, according to Example, it was possible to efficiently optimize the removal of bubbles from the slurry and the viscosity of the slurry. In case the slurry obtained in Example was used as a plugging material for a honeycomb structure, no pinholes appeared at the plugged portions after sintering in Example while the incidence of pinholes was 0.5% in Comparative Example.

A specific implementation result of a plugged honeycomb structure using a slurry obtained with the bubble removing method in accordance with the present invention as a plugging material will be described.

For example, a forming material made of a mixture of water and a binder dispersed/mixed and kneaded into the cordierite-forming material including talc, kaolin and alumina as a main material is extruded in a cylindrical shape with a pugmill. The material obtained undergoes extrusion molding with an extruder machine to obtain a formed honeycomb body. In case a honeycomb structure is manufactured using such a formed honeycomb body, the formed honeycomb body obtained is dried and cut into a predetermined length to obtain dried bodies. Cell groups at both end surfaces of each of the dried body are plugged alternately and then fired to obtain a fired body. Partition walls of about one to three cells from the outer peripheral wall and outermost periphery of thus obtained fired body are ground and removed. Then a ceramic coating material is applied to the outer periphery to form an outer peripheral wall thus obtaining a cordierite honeycomb structure. With this method, it was possible to manufacture a honeycomb structure having a rectangular cell section, a partition wall thickness of 0.3 mm, a standard cell density of 300 cpsi (45.6 cells/cm²), a cylindrical outer shape (outer diameter: 191 mm; length: 203 mm) after outer peripheral coating, and a plugging depth of 10 mm.

In a plugging process, a mask covering the opening ends of the cells other than predetermined cells is disposed at one end surface of a dried, unfired honeycomb structure. The mask is designed to introduce a ceramic slurry into predetermined cells and conventional masking means may be preferably used. For example, it is possible to use a mask prepared by affixing an adhesive sheet on one end surface of an unfired honeycomb structure and making holes at predetermined sections corresponding to predetermined cells via image processing. Next, a plugging process for filling a plugging material into cells is performed. In the process, the honeycomb structure is dried as required and the mask is removed to form plugged portions.

Use of a slurry from which bubbles are not removed causes larger bubbles to block filling of a slurry into cells. This results in reducing plugging depth of cells in the local area, which may fail to attain the accuracy of a predetermined plugging depth. Removing bubbles in accordance with the method of the present invention facilitates the removal of bubbles compared with the conventional method, thereby ensuring the accuracy of a predetermined plugging depth.

Similarly, it was possible to obtain the equivalent accuracy of a predetermined plugging depth with a honeycomb structure having a rectangular cell section, a partition wall thickness of 0.3 mm, a standard cell density of 200 cpsi (31 cells/cm²), a cylindrical outer shape (outer diameter: 229 mm; length: 305 mm) after an outer peripheral coating or a cylindrical outer shape (outer diameter: 460 mm; length: 500 mm) after an outer peripheral coating. These honeycomb structures showed the properties: a porosity of 45 to 70%, an average fine pore diameter of 5 to 30 μm, and an average thermal expansion coefficient in the axis direction at 40 to 800° C. being from about 0.1 to 1.0×10⁻⁶/° C.

The same materials were used to manufacture a honeycomb structure in diameter of 191 to 460 mm having a cell section of a combination of an octagon and a rectangle, a partition wall thickness of 0.41 mm, and a standard cell density of 300 cpsi (46.5 cells/cm²). Furthermore, a honeycomb structure having an integrally formed outer shape of a cylinder (outer diameter: 144 mm; length: 152 mm) without outer periphery processing and a plugging depth of 3 mm was manufactured. In the conventional plugging method, the accuracy of a plugging depth was 3±2 mm. However, with the method of the invention, an accuracy of 3±1 mm was obtained. This allows the plugging depth to further reduce to 1 to 2 mm.

The method for removing bubbles from a slurry and a device therefor according to the present invention are preferably used in such applications as removing bubbles from a slurry (e.g., a plugging material) used for a ceramic product of which high concentration, uniformity and denseness are required.

What is claimed is:

1. A method for removing bubbles from a slurry comprising liquid and a high concentration of solid material agitated and dispersed in the liquid with the slurry containing bubbles to be removed therein, the method comprising the step of dropping the slurry into a slurry tank under vacuum, while discharging the slurry containing bubbles to be removed therein in the form of a number of and noncontact filaments or noodles, this step being performed at least once.

2. The method for removing bubbles from a slurry according to claim 1, wherein the degree of vacuum in the slurry tank is 0.013 to 6.7 kPa.

3. The method for removing bubbles from a slurry according to claim 1, wherein the viscosity of the slurry is 50 to 500 dPa's.

4. A device for removing bubbles from a slurry, comprising:
a hopper for charging a predetermined amount of slurry comprising liquid and a high concentration of solid material agitated and dispersed in the liquid with the slurry containing bubbles to be removed therein;
a bubble removing unit disposed downstream of the hopper and having a bubble removing plate disposed downstream of the hopper for discharging the slurry containing bubbles to be removed therein in the form of a number of and noncontact filaments or noodles;
a slurry tank connected downstream of the bubble removing unit;
a vacuum unit for evacuating the slurry tank when the bubble removing unit is used; and
an air introduction unit for introducing air for pressure-delivering the slurry with bubbles removed which is contained in the slurry tank from the bubble removing unit to the outside.

5. The device for removing bubbles from a slurry according to claim 4, wherein the size of discharge holes made in the bubble removing plate is 0.5 to 20 mm in a conversion of diameter.

6. The device for removing bubbles from a slurry according to claim 4, wherein a further bubble removing unit having a similar feature to the bubble removing unit is provided in the slurry tank.

7. The device for removing bubbles from a slurry according to claim 4, wherein the bubble removing plate disposed in the bubble removing unit comprises a plurality of plates disposed in a plurality of stages, the number of stages of the bubble removing plates being 2 to 20.
